(19) United States
(12) Patent Application Publication
(10) Pub. No.: US 2011/0173776 A1
(43) Pub. Date: Jul. 21, 2011

(54) HINGE

(76) Inventor: Chung-Yu Lee, Shulin (TW)

(21) Appl. No.: 12/689,408

(22) Filed: Jan. 19, 2010

(51) Int. Cl. E05D 11/08; F16C 11/04

(52) U.S. Cl. 16/342

(57) ABSTRACT

A hinge is mounted between a cover and a body of an electronic device and has a sheath, a shaft and a positioning unit. The sheath is connected to the body and has a flat panel. The shaft is connected to the base, is mounted through the sheath and has a flat surface. The positioning unit is attached to the flat panel and has an undulated positioning member selectively abutting the flat surface of the shaft to provide positioning function and to enhance the largest torque. Moreover, the undulated positioning member increases the contact points between the shaft and the positioning unit so that the shaft is stable during rotation.

### BACKGROUND OF THE INVENTION

1. Field of the Invention

The present invention relates to a hinge, especially to a hinge mounted between a cover and a body of an electronic device.

2. Description of the Prior Arts

Notebook computers, cell phones are electronic devices and are widely used in modern life. The electronic device has a cover and a body. The cover may be pivoted relative to the body via a conventional hinge. The conventional hinge has a shaft and a sheath cooperating with each other to provide positioning function so that the cover is held to be closed and to be flush with the body stably.

However, with reference to FIG. 20, the torque providing by the conventional hinge changes with the rotating angle of the shaft relative to the sheath. The conventional hinge provides largest torque about 2 kg-cm when the rotating angle is about 15 degrees to provide positioning function. However, the average of the torque at other rotating angles is about 1.6 kg-cm. The difference between the largest torque and the average torque is too small so that the positioning effect is not obvious.

To overcome the shortcomings, the present invention provides a hinge to mitigate or obviate the aforementioned problems.

### SUMMARY OF THE INVENTION

The main objective of the present invention is to provide a hinge that has an enhanced largest torque to provide positioning function. The hinge is mounted between a cover and a body of an electronic device and has a sheath, a shaft and a positioning unit. The sheath is connected to the body and has a flat panel. The shaft is connected to the base, is mounted through the sheath and has a flat surface. The positioning unit is attached to the flat panel and has an undulated positioning member selectively abutting the flat surface of the shaft to provide positioning function and to enhance the largest torque. Moreover, the undulated positioning member increases the contact points between the shaft and the positioning unit so that the shaft is stable during rotation.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is another exploded perspective view of the hinge in FIG. 1;

FIG. 4 is a graph depicting number of rotating angle plotted against torque of the hinge in FIG. 1;

FIG. 5 is a perspective view of a sheath of the hinge in FIG. 1;

FIG. 6 is a perspective view of a sheath of a second embodiment of a hinge in accordance with the present invention;

FIG. 7 is a perspective view of a sheath of a third embodiment of a hinge in accordance with the present invention;

FIG. 8 is a perspective view of a sheath of a fourth embodiment of a hinge in accordance with the present invention;

FIG. 9 is another perspective view of the sheath in FIG. 8;

FIG. 10 is a perspective view of a sheath of a fifth embodiment of a hinge in accordance with the present invention;

FIG. 11 is another perspective view of the sheath in FIG. 10;

FIG. 12 is a perspective view of a sheath of a sixth embodiment of a hinge in accordance with the present invention;

FIG. 13 is a perspective view of a sheath of a seventh embodiment of a hinge in accordance with the present invention;

FIG. 14 is an exploded perspective view of an eighth embodiment of a hinge in accordance with the present invention;

FIG. 15 is a perspective view of a positioning unit of a ninth embodiment of a hinge in accordance with the present invention;

FIG. 16 is a perspective view of a sheath and a positioning unit of a tenth embodiment of a hinge in accordance with the present invention;

FIG. 17 is a perspective view of a positioning unit of an eleventh embodiment of a hinge in accordance with the present invention;

FIG. 18 is a perspective view of a positioning unit of a twelfth embodiment of a hinge in accordance with the present invention;

FIG. 19 is a perspective view of a positioning unit of a thirteenth embodiment of a hinge in accordance with the present invention; and

FIG. 20 is a graph depicting number of rotating angle plotted against torque of a conventional hinge in accordance with the present invention.

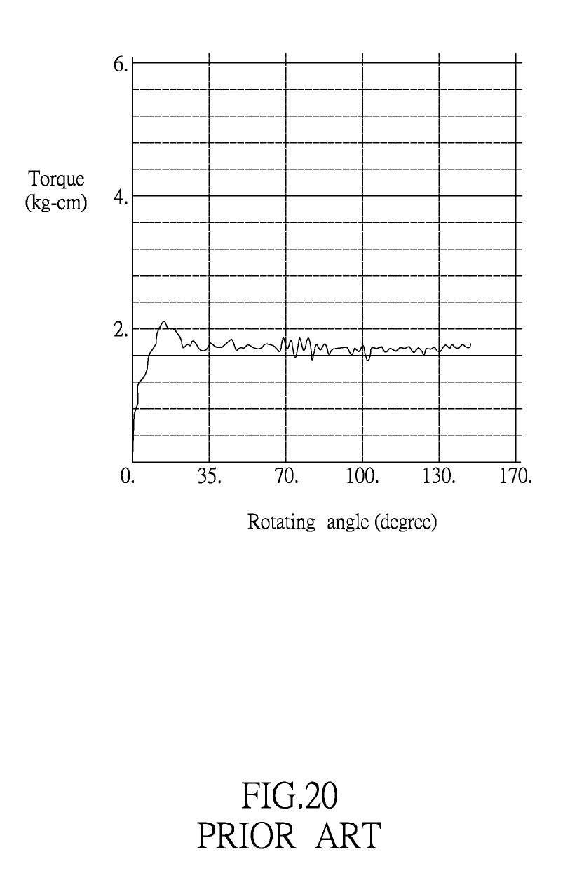

### DETAILED DESCRIPTION OF THE PREFERRED EMBODIMENTS

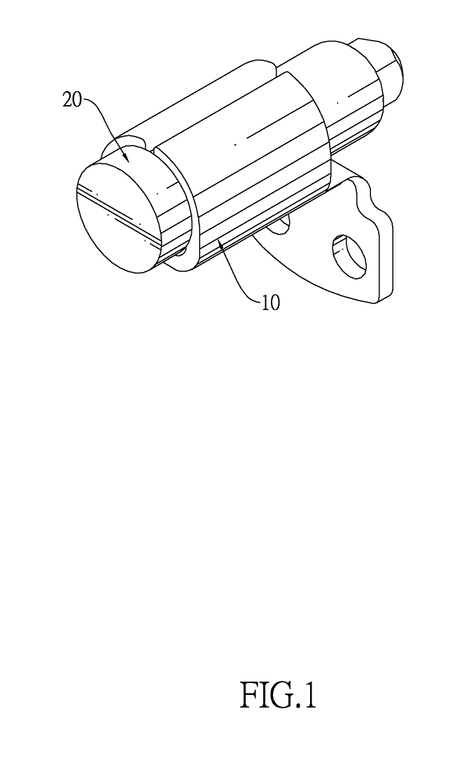

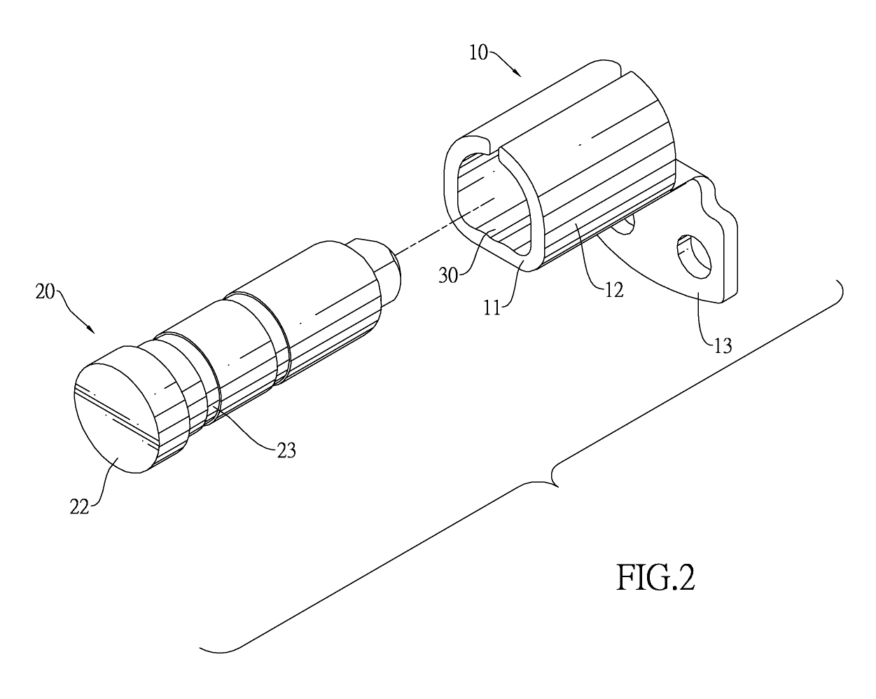

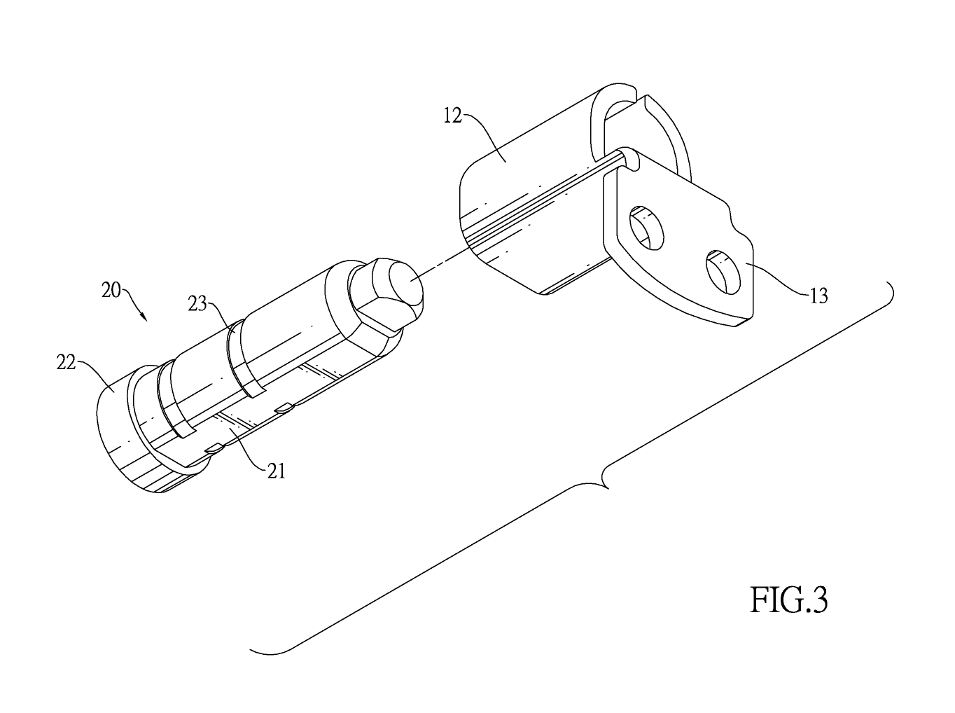

With reference to FIG. 1, a hinge in accordance with the present invention comprises a sheath (10), a shaft (20) and a positioning unit (30). With reference to FIGS. 2 and 3, the sheath (10) has a flat panel (11), a mounting segment (12) and a fastening wing (13). The mounting segment (12) is formed curvedly from side edges of the flat panel (11) to form a mounting cavity between the mounting segment (12) and the flat panel (11). The fastening wing (13) protrudes from a periphery of the flat panel (11).

The shaft (20) is mounted through the mounting cavity and has a flat surface (21), an enlarged head (22) and multiple grooves (23). The flat surface (21) is formed on an outside wall of the shaft (20). The enlarged head (22) is formed on an end of the shaft (20). The grooves (23) are formed in the outside wall of the shaft (20) to accommodate lubricant.

The positioning unit (30) is attached to the flat panel (11) and has an undulated positioning member selectively abutting against the flat surface of the shaft (20) to provide positioning function.

The hinge as described is mounted between a cover and a body of an electronic device. The shaft (20) is connected to the cover. The fastening wing (13) of the sheath (10) is connected to the body. When the cover is pivoted relative to the body, the shaft (20) is rotated relative to the sheath (10). When the flat surface (21) of the shaft (20) abuts the positioning unit (30), the hinge as described provides largest torque to generate positioning function.

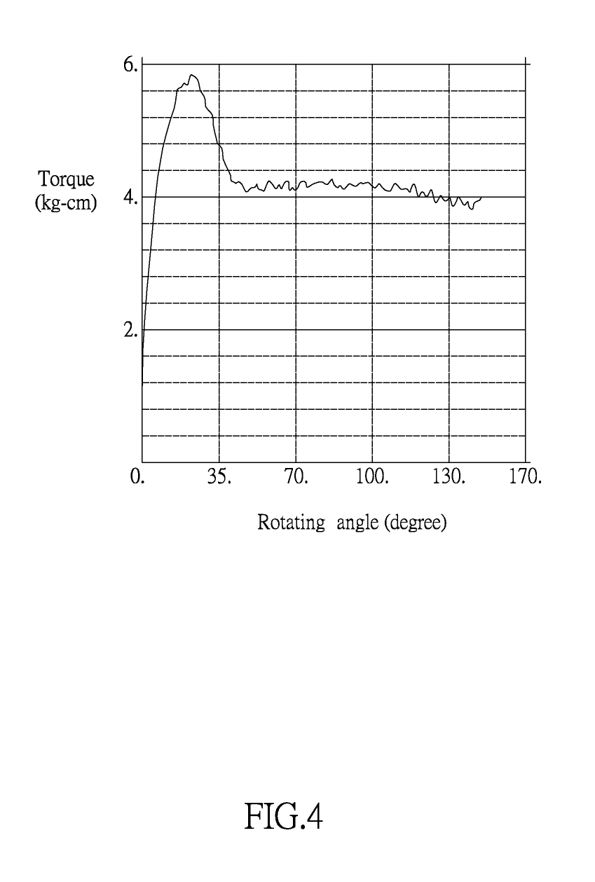

With further reference to FIG. 4, the hinge as described provides largest torque 6 kg-cm during 0 to 35 degrees. The average of the torque at other rotating angles is about 4 kg-cm. Since the largest torque is far more than the average torque, the positioning effect is obvious to hold the cover in position. Furthermore, with the undulated positioning member of the positioning unit (30), the shaft (20) and the sheath (10) has more than three contact points during relative rotation so that the shaft (20) is stable during rotation. Therefore, the hinge as described provides steady torque as shown in FIG. 4, especially among the rotating angles larger than 35 degrees.

The self-lock hinge in accordance with the present invention has basic structure as mentioned above. The alternative structures are described below.

The mounting segment of the sheath has multiple alternative structures.

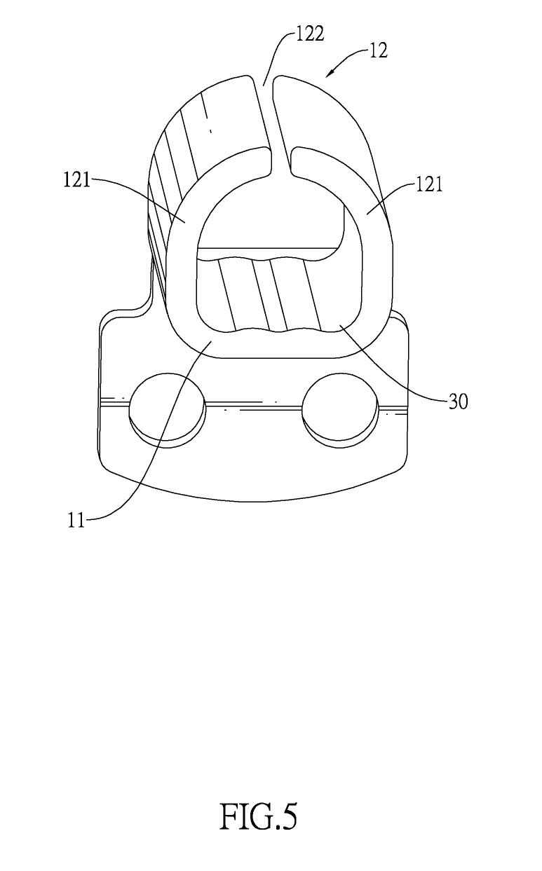

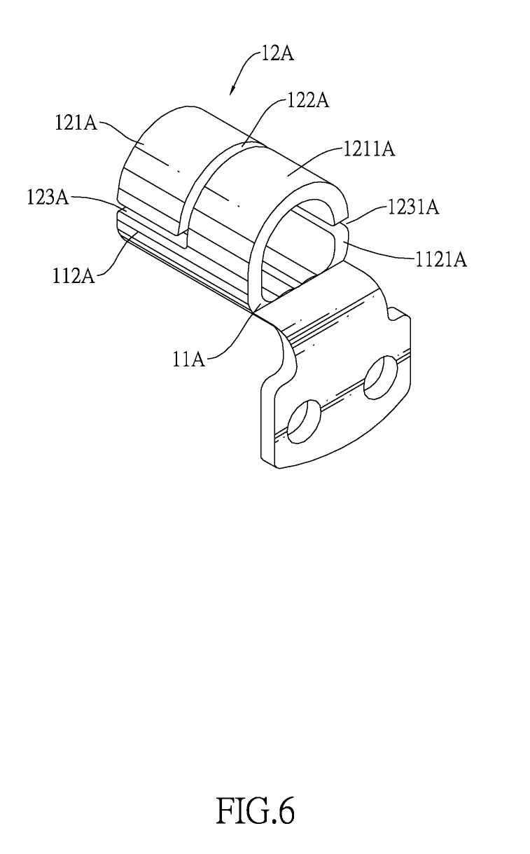

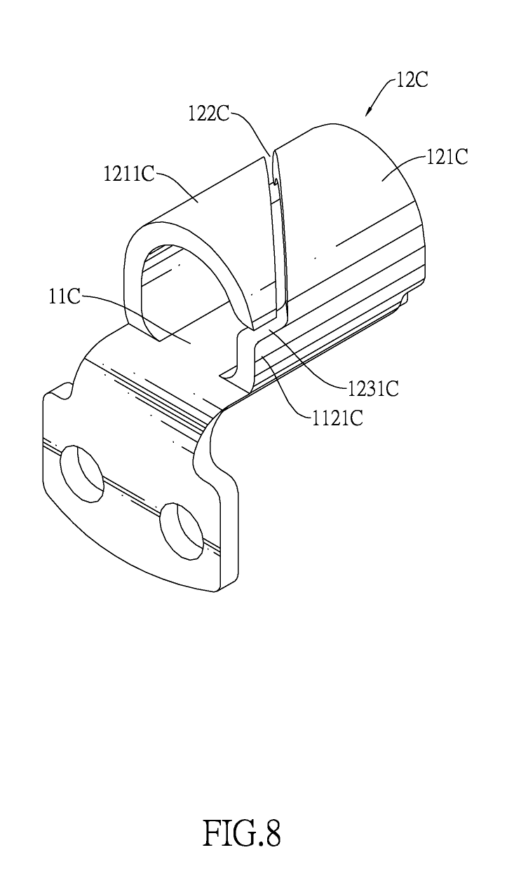

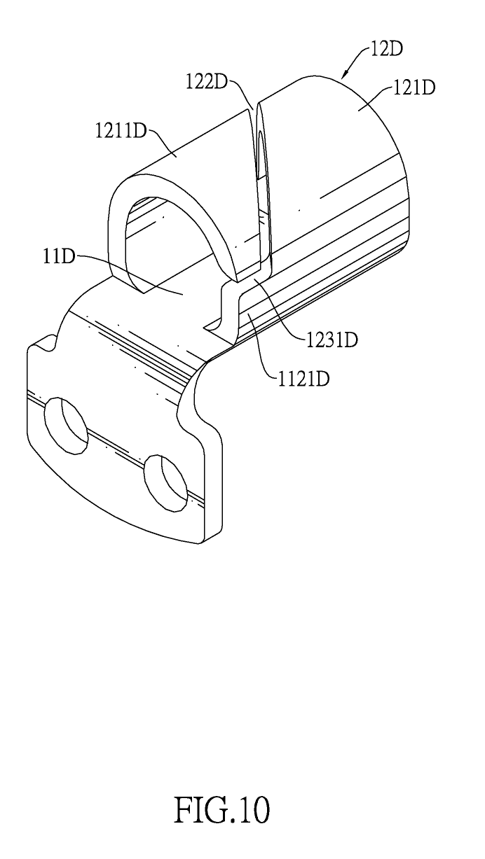

In a preferred embodiment as shown in FIG. 5, the mounting segment (12) has two arms (121). The longitudinal length of each arm (121) is the same with the longitudinal length of the flat panel (11). The arms (121) respectively protrude curvedly from the side edges of the flat panel (11) and are bent toward each other so that a slit (122) is formed between adjacent ends of the arms (121). The fastening wing (13) protrudes from an end of the flat panel (11). The mounting segment (12A, 12B, 12C, 12D) as shown in FIGS. 6 to 11 comprises a first arm (121A, 121B, 121C, 121D) and a second arm (1211A, 1211B, 1211C, 1211D). The longitudinal length of the first arm (121A, 121B, 121C, 121D) and the longitudinal length of the second arm (1211A, 1211B, 1211C, 1211D) are all smaller than the longitudinal length of the flat panel (11A, 11B, 11C, 11D). The first arm (121A, 121B, 121C, 121D) is formed near a front end of the flat panel (11A, 11B, 11C, 11D). The second arm (1211A, 1211B, 1211C, 1211D) is formed near a rear end of the flat panel (11A, 11B, 11C, 11D). A slit (122A, 122B, 122C, 122D) is formed between adjacent ends of the first arm (121A, 121B, 121C, 121D) and the second arm (1211A, 1211B, 1211C, 1211D). The slit (122A, 122B, 122C, 122D) may be lateral or oblique. Preferably, the first arm (121A, 121B, 121C, 121D) protrudes curvedly from a first side edge of the flat panel (11A, 11B, 11C, 11D) toward a second side edge. The second arm (1211A, 1211B, 1211C, 1211D) protrudes curvedly from the second side edge of the flat panel (11A, 11B, 11C, 11D) toward the first side edge.

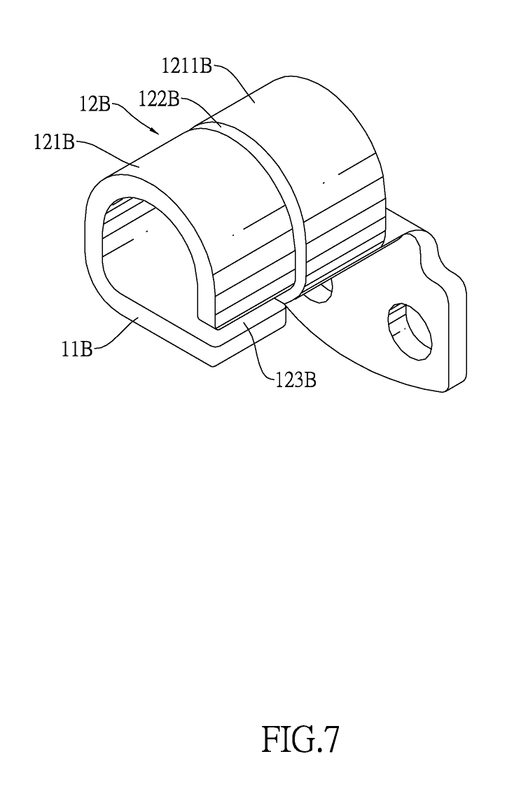

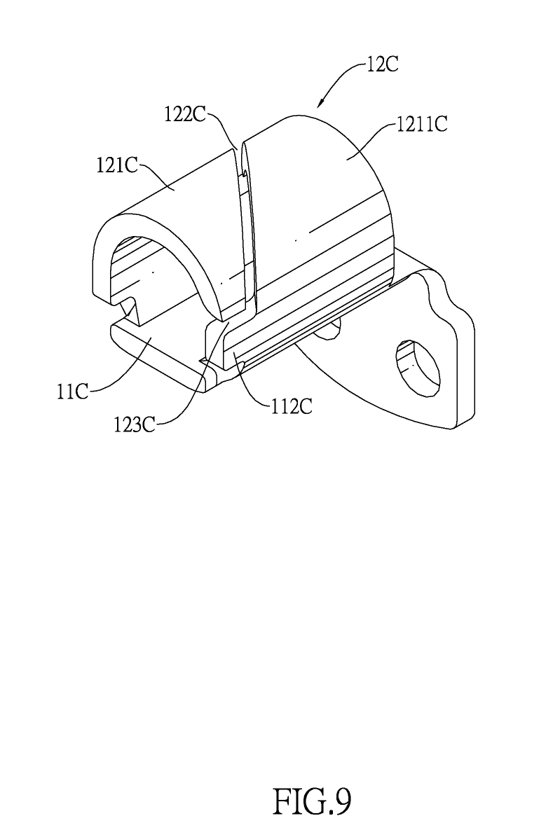

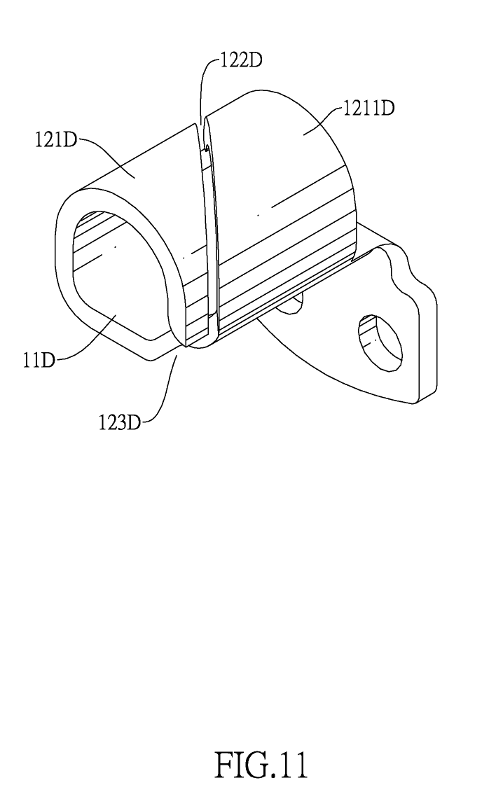

In preferred embodiments, a first gap (123B, 123D) may be formed between a distal edge of the first arm (121B, 121D) and the second side edge of the flat panel (11B, 11D) as shown in FIGS. 7 and 11. In other preferred embodiments as shown in FIGS. 6 and 9, a first gap (123A, 123C) may be formed between a distal edge of the first arm (121A, 121C) and a first lip (112A, 112C) formed on the second side edge of the flat panel (11A, 11C).

In preferred embodiments, a second gap may be formed between a distal edge of the second arm (1211B) and the first side edge of the flat panel (11B). In other preferred embodiments as shown in FIGS. 6, 8 and 10, a second gap (1231A, 1231C, 1231D) may be formed between a distal edge of the second arm (1211A, 1211C, 1211D) and a second lip (1121A, 1121C, 1211D) formed on the first side edge of the flat panel (11A, 11C, 11D).

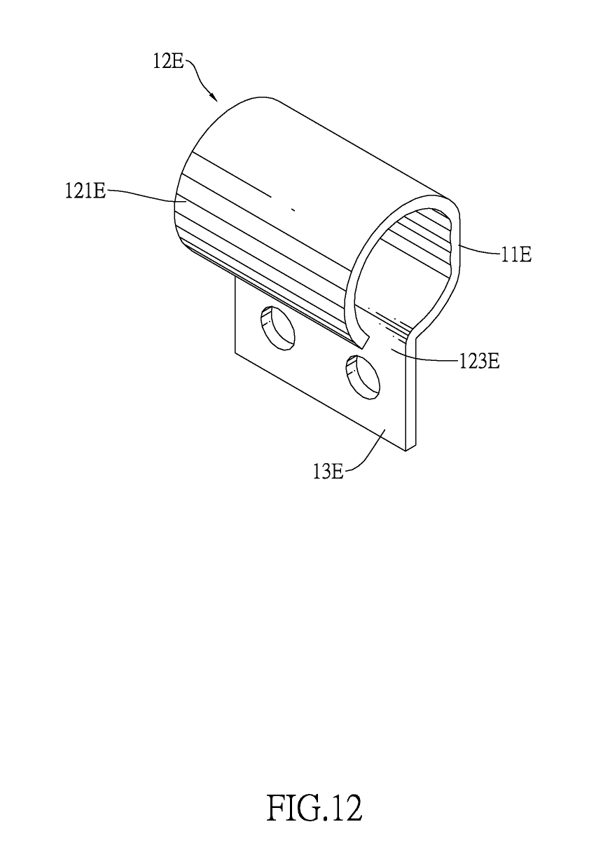

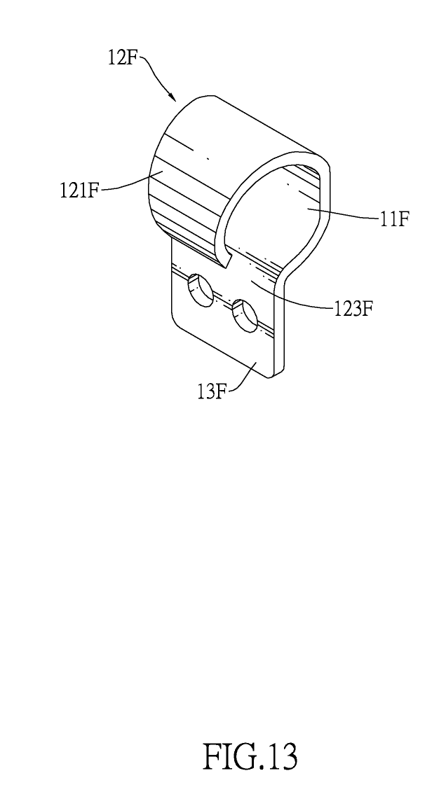

In preferred embodiments as shown in FIGS. 12 and 13, the mounting segment (12E, 12F) has one single arm (121E, 121F) protrudes curvedly from a first side edge of the flat panel (11E, 11F). The fastening wing (13E, 13F) protrudes from a second side edge of the flat panel (11E, 11F). A gap is formed between the arm (121E, 121F) and the fastening wing (13E, 13F). The longitudinal length of the arm (121E) may be the same with the longitudinal length of the flat panel (11E). The arm (121F) may be tapered.

In a preferred embodiment as shown in FIG. 2, the positioning unit (30) is integrated with the flat panel (11) of the sheath (10).

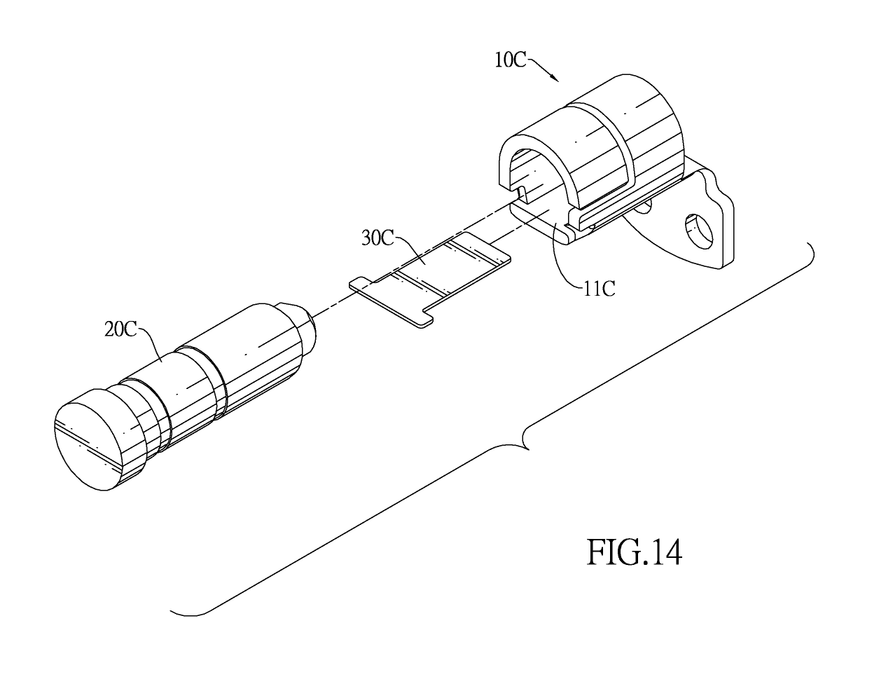

In preferred embodiment as shown in FIG. 14, the positioning unit (30C) is a single panel and is flush with the flat panel (11C) of the sheath (10C). The degree of tightness between the sheath (10C) and the shaft (20C) effects the output torque of the hinge as described. Adjusting the output torque usually needs to modify the size of the sheath (10C) by manufacturing other mold for the sheath (10C). However, the sheath (10C) has a complicated shape so that preparing multiple molds with different sizes for the sheath (10C) increases cost. However, modifying the thickness of a single panel is much easier and costs less. Therefore, with the positioning unit (30C) as a single panel being flush with the flat panel (11C) is beneficial to adjust the output torque of the hinge as described.

The positioning member on the positioning unit has alternative configurations to stabilize the rotating of the shaft.

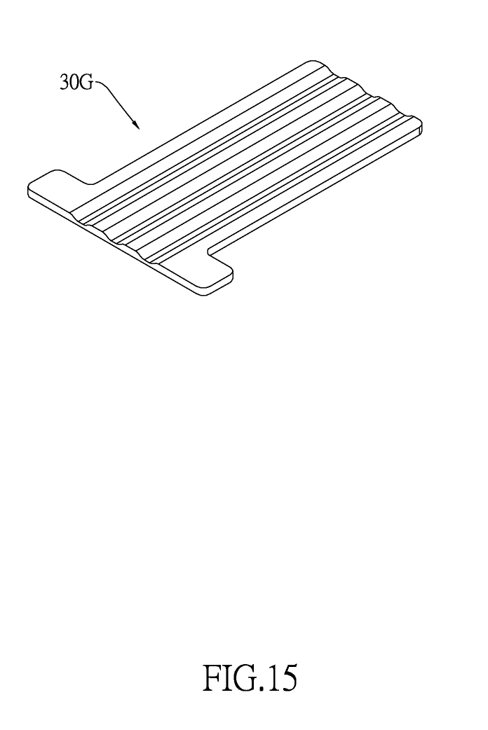

In preferred embodiments as shown in FIGS. 5 and 15, the positioning member of the positioning unit (30, 30G) is longitudinally formed thereon and has two peaks.

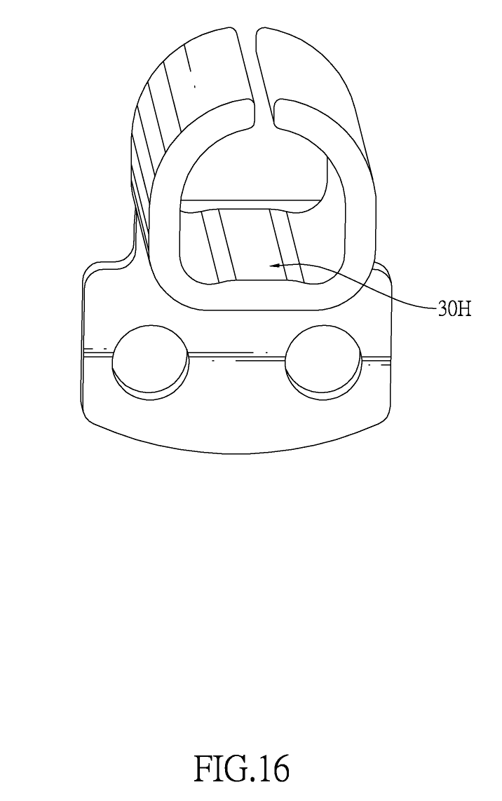

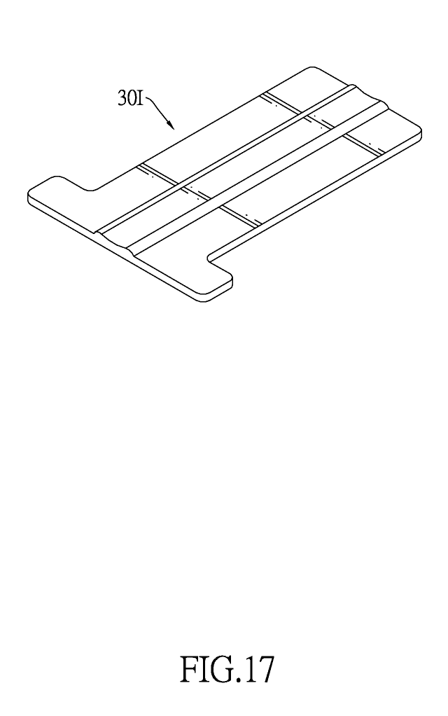

In preferred embodiments as shown in FIGS. 16 and 17, the positioning member of the positioning unit (30H, 30I) is longitudinally formed thereon and has a single peak.

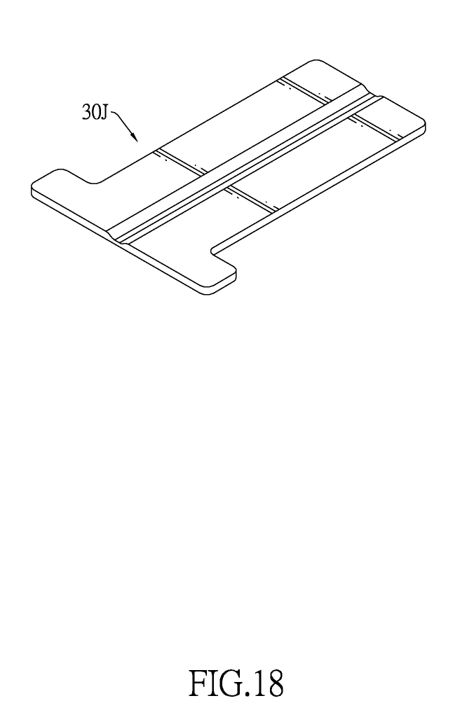

In a preferred embodiment as shown in FIG. 18, the positioning member of the positioning unit (30J) is formed longitudinally therein and has a single concave.

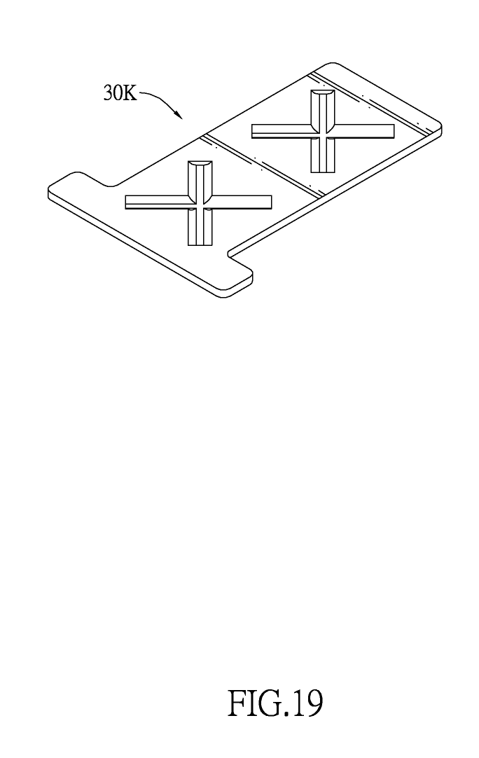

In a preferred embodiment as shown in FIG. 19, the positioning member of the positioning unit (30K) has multiple concave formed irregularly therein.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a sheath having
a flat panel;
a mounting segment formed curvedly from side edges of the flat panel to form a mounting cavity between the mounting segment and the flat panel; and
a fastening wing protruding from a periphery of the flat panel;
a shaft mounted through the mounting cavity and having a flat surface formed on an outside wall of the shaft; and
a positioning unit attached to the flat panel and having an undulated positioning member selectively abutting against the flat surface of the shaft.

2. The hinge as claimed in claim 1, wherein the positioning member of the positioning unit is longitudinally formed thereon and has two peaks.

3. The hinge as claimed in claim 1, wherein the positioning member of the positioning unit is longitudinally formed thereon and has a single peak.

4. The hinge as claimed in claim 1, wherein the positioning member of the positioning unit is formed longitudinally therein and has a single concave.

5. The hinge as claimed in claim 1, wherein the positioning member of the positioning unit has multiple concave formed irregularly therein.

6. The hinge as claimed in claim 1, wherein the positioning unit is integrated with the flat panel of sheath.

7. The hinge as claimed in claim 1, wherein the positioning unit is a single panel and is flush with the flat panel of the sheath.

8. The hinge as claimed in claim 1, wherein
the mounting segment has
two arms respectively protruding curvedly from the side edges of the flat panel and bent toward each other, wherein the longitudinal length of each arm is the same with the longitudinal length of the flat panel; and
a slit formed between adjacent ends of the arms; and
the fastening wing protrudes from an end of the flat panel.

9. The hinge as claimed in claim 1, wherein
the mounting segment has
a first arm protruding curvedly from a first side edge toward a second side edge of the flat panel and formed near a front end of the flat panel, wherein the longitudinal length of the first arm is smaller than the longitudinal length of the flat panel;
a second arm protruding curvedly from the second side edge toward the first side edge of the flat panel and formed near a near end of the flat panel, wherein the longitudinal length of the second arm is smaller than the longitudinal length of the flat panel; and
a slit formed between adjacent ends of the first and second arms;
the fastening wing protrudes from one of the ends of the flat panel.

10. The hinge as claimed in claim 9, wherein
a first gap is formed between a distal edge of the first arm and the second side edge of the flat panel; and
a second gap is formed between a distal edge of the second arm and the first side edge of the flat panel.

11. The hinge as claimed in claim 9, wherein
the flat panel has
a fist lip formed on the second side edge of the flat panel; and
a second lip formed on the first side edge of the flat panel
a first gap is formed between a distal edge of the first arm and the first lip of the flat panel; and
a second gap is formed between a distal edge of the second arm and the second lip of the flat panel.

12. The hinge as claimed in claim 9, wherein
the flat panel has a second lip formed on the first side edge of the flat panel
a first gap is formed between a distal edge of the first arm and the second side edge of the flat panel; and
a second gap is formed between a distal edge of the second arm and the second lip of the flat panel.

13. The hinge as claimed in claim 9, wherein the slit of the mounting segment is lateral.

14. The hinge as claimed in claim 9, wherein the slit of the mounting segment is oblique.

15. The hinge as claimed in claim 1,
the mounting segment has one single arm protruding curvedly from a first side edge of the flat panel;
the fastening wing protrudes from a second side edge of the flat panel; and
the sheath has a gap formed between the arm and the fastening wing.

16. The hinge as claimed in claim 15, wherein the longitudinal length of the arm is the same with the longitudinal length of the flat panel.

17. The hinge as claimed in claim 15, wherein the arm is tapered.
